(19) United States
(12) Patent Application Publication
(10) Pub. No.: US 2010/0107360 A1
(43) Pub. Date: May 6, 2010

(54) Caster assembly

(75) Inventor: Li-Huei Shih, Taichung Hsien (TW)

Correspondence Address: CHARLES E. BAXLEY, ESQUIRE, 90 JOHN STREET, SUITE 309, NEW YORK, NY, 10038, US

(73) Assignee: Tung Chieh Industries Co., Ltd.

(21) Appl. No.: 12/290,499

(22) Filed: Oct. 30, 2008

(51) Int. Cl. B60B 33/00

(52) U.S. Cl. 16/21; 16/35 R; 16/20

(57) ABSTRACT

A caster assembly includes a caster, a fork for supporting the caster and a connecting unit for rotationally connecting the fork to a vehicle. There is provided a braking unit for stopping the rolling of the caster. There is provided a restraining for stopping the steering of the vehicle when the rolling of the caster is stopped.

### FIELD OF INVENTION

The present invention relates to a caster assembly that is attached to and can be steered relative to a vehicle and, more particularly, to a caster assembly including a braking unit for stopping the rolling thereof and a restraining unit for stopping the steering thereof.

### BACKGROUND OF INVENTION

Referring to FIG. 1, a conventional caster assembly 10 includes a caster 11, a fork 12 for supporting the caster 11 rotationally and a braking unit for stopping the rolling of the caster 11. The braking unit includes a brake 15 and a pedal 17. The fork 12 includes two prongs 13. The brake 15 includes a pedal-connecting portion transversely extended from a caster-contacting portion 154. Two tabs 151 and 153 are formed on a side of the pedal-connecting portion of the brake 15. A slot 152 is defined in the pedal-connecting portion of the brake 15. A middle portion of the pedal 17 is formed as a cam 171. An axle 18 is inserted through the cam 171, the slot 152, the prongs 13 and the caster 11. A nut 181 is engaged with a threaded portion formed at each end of the axle 18. When an end of the pedal 17 is trodden, the cam 171 is in contact with the tab 153 so that the caster-contacting portion 154 is in contact with the caster 11. Hence, the rolling of the caster 11 is stopped. When another end of the pedal 17 is trodden, the cam 171 is in contact with the tab 151 so that the caster-contacting portion 154 is removed from the caster 11. Hence, the rolling of the caster 11 is allowed.

In use, the fork 12 is non-rotationally attached to a vehicle such as a skate board and trolley. Therefore, the vehicle equipped with the caster assembly 10 cannot be steered.

To overcome the above-mentioned problem, there is a second conventional caster assembly including a fork that can rotationally be attached to a vehicle. The second conventional caster assembly enables the vehicle to be steered when it is encountered with a slope. The automatic steering of the second conventional caster assembly might release the braking of the second conventional caster assembly in the worst case.

The present invention is therefore intended to obviate or at least alleviate the problems encountered in prior art.

### SUMMARY OF INVENTION

It is the primary objective of the present invention to provide a caster assembly including a braking unit for stopping the rolling thereof and a restraining unit for stopping the steering thereof.

To achieve the foregoing objective, the caster assembly includes a caster, a fork for supporting the caster and a connecting unit for rotationally connecting the fork to a vehicle. The fork includes a slot defined therein. The connecting unit includes recesses defined therein. The braking unit includes a brake and a pedal. The brake is connected to the fork and formed with a caster-contacting portion inserted through the slot, a pedal-connecting portion transversely extended from the caster-contacting portion, an upper tab formed on the pedal-connecting portion and a lower tab formed on the pedal-connecting portion. The pedal is located next to the brake and changeable between a releasing position and a braking position. In the releasing position, the pedal is in contact with the upper tab so that the caster-contacting portion of the brake is away from the caster. In the braking position, the pedal is in contact with the lower tab so that the caster-contacting portion of the brake is in contact with the caster. The restraining unit includes a brake-engaging element and a latch. The brake-engaging element is engaged with the brake so that the brake-engaging element can be pivoted between a releasing position corresponding to the releasing position of the pedal and a restraining position corresponding to the braking position of the pedal. The latch is connected to the brake-engaging element so that the latch is inserted in one of the apertures of the disc in the restraining position and that the latch is removed from the apertures of the disc in the releasing position.

Other objectives, advantages and features of the present invention will become apparent from the following description referring to the attached drawings.

### BRIEF DESCRIPTION OF DRAWINGS

The present invention will be described via the detailed illustration of the preferred embodiment versus the prior art referring to the drawings.

FIG. 1 is a perspective view of a conventional caster assembly.

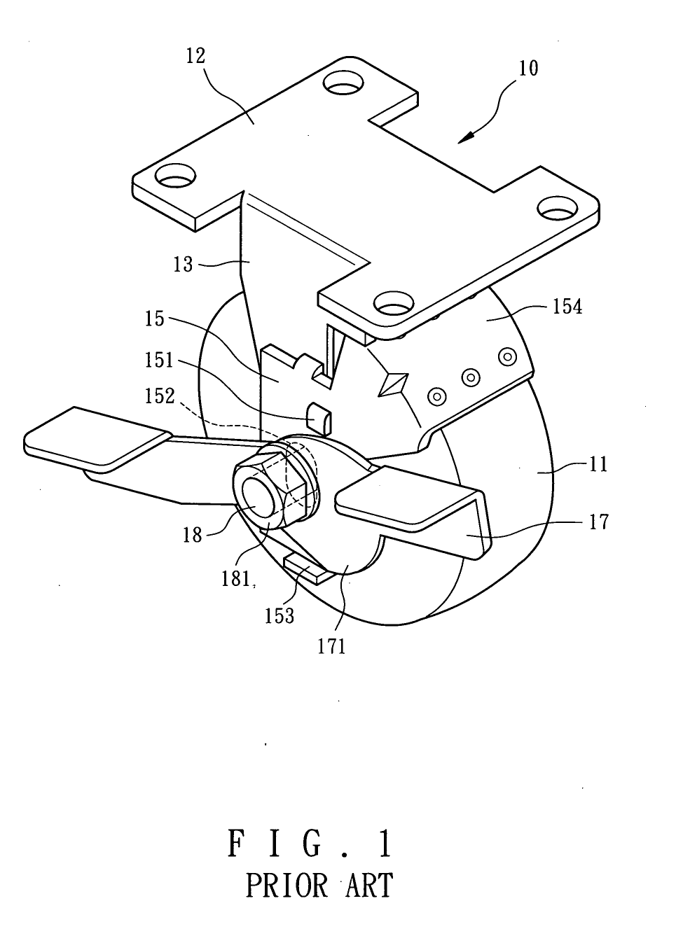

FIG. 2 is a perspective view of a caster assembly according to the preferred embodiment of the present invention.

FIG. 3 is an exploded view of the caster assembly shown in FIG. 2.

FIG. 4 is another perspective view of the caster assembly shown in FIG. 2.

FIG. 5 is a side view of the caster assembly shown in FIG. 4.

FIG. 6 is a side view of the caster assembly in another position than shown in FIG. 5.

### DETAILED DESCRIPTION OF PREFERRED EMBODIMENT

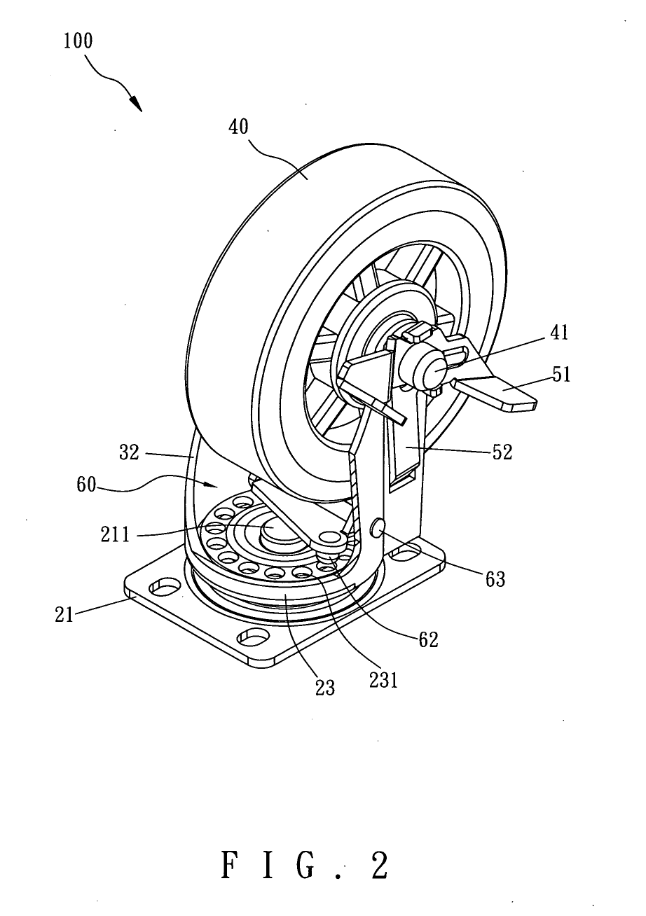

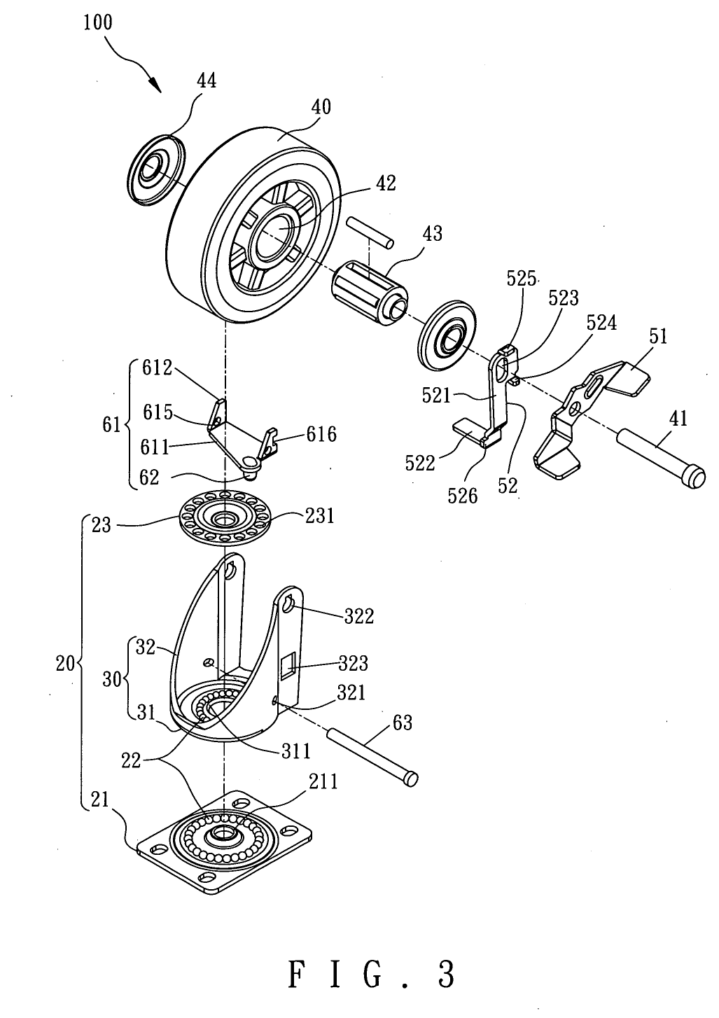

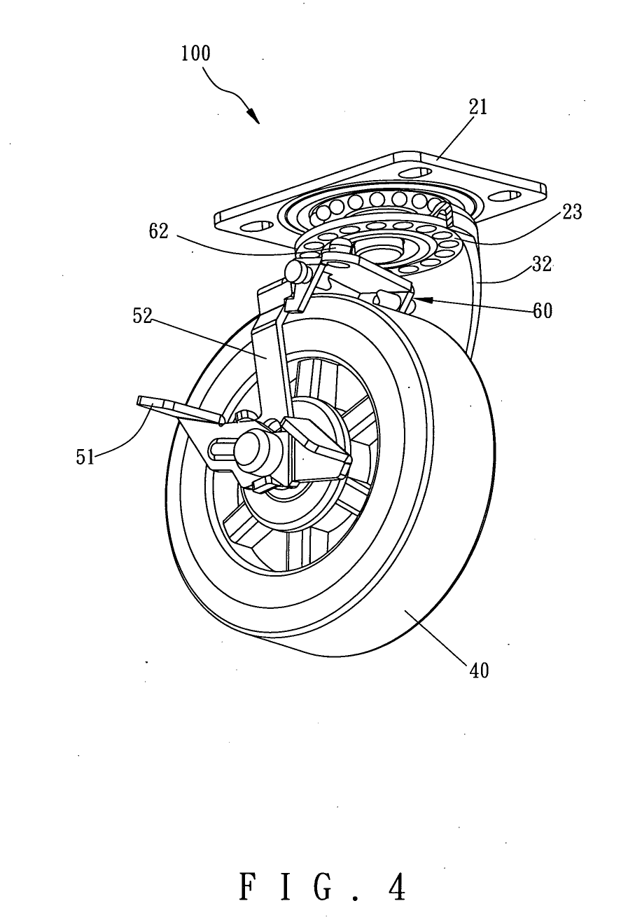

Referring to FIGS. 2 to 4, a caster assembly 100 includes a caser 40, a fork 30 for supporting the caster 40, a connecting unit 20 for rotationally connecting the fork 30 to a vehicle such as a skate board and trolley, a braking unit 50 for stopping the rolling thereof and a restraining unit 60 for stopping the steering thereof according to the preferred embodiment of the present invention. The caster 40 includes an aperture 42 defined therein. A bearing 43 is disposed in the aperture 42. An axle 41 is inserted through the bearing 43. Two annular covers 44 are attached to the caster 40 for protecting the bearing 43.

The fork 30 includes two prongs 32 transversely extended from a middle portion 31. An aperture 311 is defined in the middle portion 31 of the fork 30. Two apertures 321 and 322 are defined in each of the prongs 32. A slot 323 is defined in one of the prongs 32.

The connecting unit 20 includes a plate 21, a disc 23 and a bearing 22. The plate 21 is non-rotationally attached to the vehicle. The plate 21 is formed with a rivet 211 at the center. Recesses 231 are evenly defined in the disc 23. The bearing 22 includes two groups of balls. The first group of balls is located between the plate 21 and the middle portion 31 of the fork 30. The second group of balls is located between the disc 23 and the middle portion 31 of the fork 30. Therefore, the fork 30 is rotationally attached to the vehicle with the connecting unit 20. Inserted through the aperture 311, the rivet 211 is non-rotationally connected to the disc 23. Hence, the disc 23 is non-rotational relative to the plate 21.

The braking unit 50 includes a brake 52 and a pedal 51. The brake 52 includes a pedal-connecting portion 521 transversely extended from a caster-contacting portion 522. The caster-contacting portion 522 of the brake 52 is inserted through the slot 323. Two tabs 524 and 525 are formed on the pedal-connecting portion 521 of the brake 52. A slot 523 is defined in the pedal-connecting portion 521 of the brake 52. The axle 41 is inserted through the pedal 51 and the slot 523 of the brake 52. A tongue 526 is transversely extended from the pedal-connecting portion 521 of the brake 52.

The restraining unit 60 includes a brake-engaging element 61 and a latch 62. The brake-engaging element 61 includes two wings 612 extended from a middle portion 611. An aperture 615 is defined in each of the wings 612. A cutout 616 is defined in one of the wings 612. The latch 62 is connected to the middle portion 611 of the brake-engaging element 61. A pin 63 is inserted through the apertures 321 and 615. The tongue 526 of the brake 52 is disposed in the cutout 616 of the brake-engaging element 61.

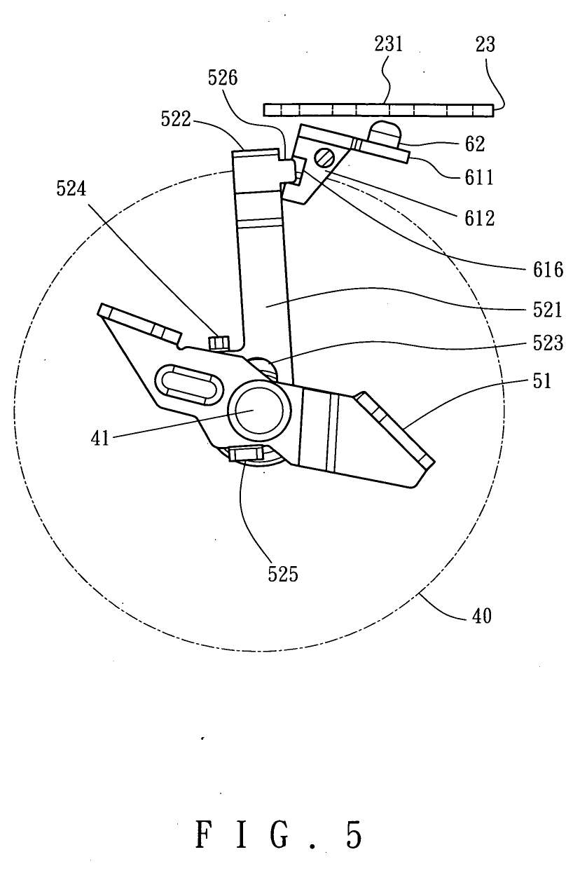

Referring to FIG. 5, an end of the pedal 51 is trodden so that a middle portion of the pedal 51 is in contact with the tab 524 and that the caster-contacting portion 522 of the brake 52 is away from the caster 40. Hence, the rolling of the caster 40 is allowed. The latch 62 is not inserted in any of the recesses 231 of the disc 23 so that the steering of the vehicle is allowed.

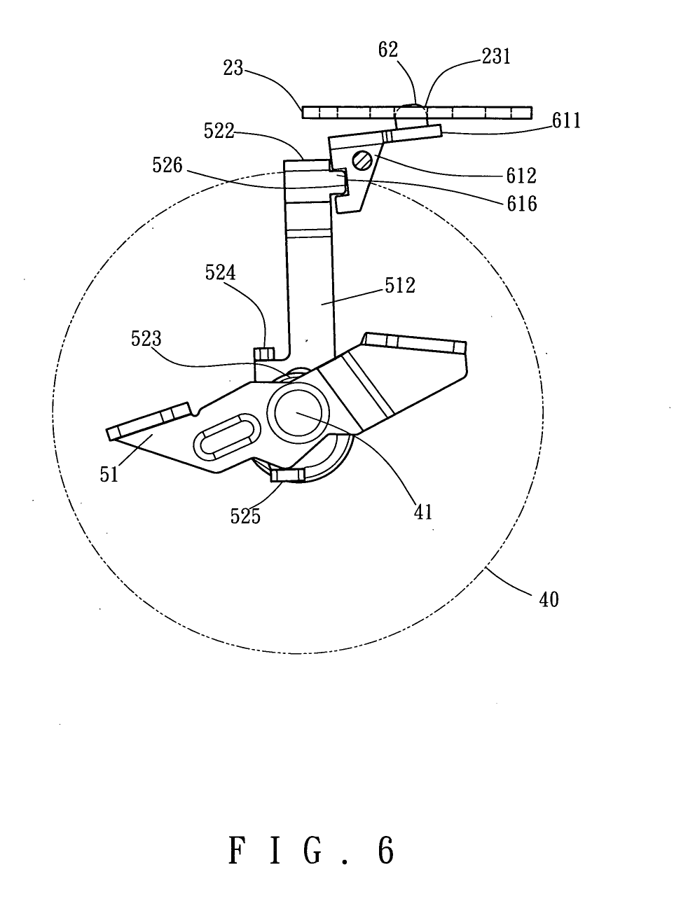

Referring to FIG. 6, another end of the pedal 51 is trodden so that the pedal 51 is in contact with the tab 525 and that the caster-contacting portion 522 of the brake 52 is in contact with the caster 40. Hence, the rolling of the caster 40 is stopped. The brake-engaging element 61 is pivoted with the brake 52. The latch 62 is inserted in one of the recesses 231 of the disc 23 so that the steering of the vehicle is avoided.

Advantageously, the rolling of the caster 40 and the steering of the vehicle can be allowed simultaneously so that the vehicle can be driven easily. On the other hand, the rolling of the caster 40 and the steering of the vehicle can be avoided simultaneously so that the vehicle can be parked firmly.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A caster assembly comprising:
a caster;
a fork for supporting the caster, wherein the fork comprises a slot defined therein;
a connecting unit for rotationally connecting the fork to a vehicle, wherein the connecting unit comprises recesses defined therein;
a braking unit comprising:
a brake connected to the fork and formed with a caster-contacting portion inserted through the slot, a pedal-connecting portion transversely extended from the caster-contacting portion, an upper tab formed on the pedal-connecting portion and a lower tab formed on the pedal-connecting portion; and
a pedal located next to the brake and changeable between a releasing position where the pedal is in contact with the upper tab so that the caster-contacting portion of the brake is away from the caster and a braking position where the pedal is in contact with the lower tab so that the caster-contacting portion of the brake is in contact with the caster; and
a restraining unit comprising:
a brake-engaging element engaged with the brake so that the brake-engaging element can be pivoted between a releasing position corresponding to the releasing position of the pedal and a restraining position corresponding to the braking position of the pedal; and
a latch connected to the brake-engaging element so that the latch is inserted in one of the apertures of the disc in the restraining position and that the latch is removed from the apertures of the disc in the releasing position.

2. The caster assembly according to claim 1, wherein the connecting unit comprises:
a plate;
a disc formed with the recesses and non-rotationally attached to the plate; and
a bearing for ensuring the smooth pivoting of the fork relative to the plate.

3. The caster assembly according to claim 2, wherein the plate comprises a rivet inserted through the fork and non-rotationally secured to the disc.

4. The caster assembly according to claim 2, wherein the fork comprises a middle portion located between the plate and the disc and two prongs extended from the middle portion, wherein the caster is connected to the prongs and the slot is defined in one of the prongs.

5. The caster assembly according to claim 4, wherein the bearing comprises a group of balls between the plate and the middle portion of the fork and another group of balls between the disc and the middle portion of the fork.

6. The caster assembly according to claim 4 comprising an axle inserted through the prongs and the caster.

7. The caster assembly according to claim 6, wherein the pedal-connecting portion of the brake comprises a slot through which the axle is inserted.

8. The caster assembly according to claim 4 comprising a pin inserted through the prongs and the brake-engaging element.

9. The caster assembly according to claim 8, wherein the brake-engaging element comprises a middle portion and two wings extended from the middle portion, wherein the latch is connected to the middle portion of the brake-engaging element and the pin is inserted through the wings of the brake-engaging element.

10. The caster assembly according to claim 9, wherein the brake comprises a tongue extended from the pedal-connecting portion and one of the wings of the brake-engaging element comprises a cutout for receiving the tongue.

11. The caster assembly according to claim 1, wherein the brake-engaging element and the latch are made one.
